(19) United States
(12) Patent Application Publication
(10) Pub. No.: US 2009/0277018 A1
(43) Pub. Date: Nov. 12, 2009

(54) Sheet Metal Profile Cutter

(76) Inventor: Mario Arena, Victoria (AU)

Correspondence Address: KEVIN J. MCNEELY, ESQ., 5335 WISCONSON AVENUE, NW, SUITE 440, WASHINGTON, DC, 20015, US

(21) Appl. No.: 11/913,640

(22) PCT Filed: May 4, 2005
(86) PCT No.: PCT/AU2005/000632

§ 371 Date: Nov. 5, 2007

(51) Int. Cl. B23D 29/02

(52) U.S. Cl. 30/252

(57) ABSTRACT

A device for cutting sheet metal is disclosed. The device comprises of a cutting blade (13) which passes between two curved sharpened support blades (12 & 14) (“curved support blades”), the latter which curves away from the cutting blade (13). The cutting blade (13) and the curved support blades (12 & 14) each have two holes in them (henceforth referred to as upper and lower holes) which enable them to be connected together and to the handles (4 & 5). The handles (4 & 5) are long and similar to those commonly used in long handle pruning secateurs. Items (3 & 6) each have two holes in them (henceforth referred to as upper and lower holes) which enable them to be connected together and to the cutting blade (13) and the curved support blades (12 & 14). Items (3 & 6) are bolted together at their upper holes, and at the other ends they slot into the handles (4 & 5). The cutting blade (13) and the two curved support blades (12 & 14) are bolted together at their upper holes, with the cutting blade (13) fitting between the two curved support blades (12 & 14). The two curved support blades (12 & 14) are connected to either side of item (6), and they are all bolted together at their respective lower holes. The cutting blade (13) is bolted to item (3) at the lower holes of both items. The two curved support blades (12 & 14) are held together by a bracket (1) which keeps the former parallel to each other and demarcates the space for which the cutting blade (13) passes through. The cutting blade (13) is straight, however the face of the blade is angled to one side to assist with the cutting.

### BACKGROUND OF THE INVENTION

The present invention is designed primarily to cut penetrations in sheet metal (roofing, ducting, cladding & metal decking) of various profiles. This is a task that plumbers and builders routinely need to perform. There are many devices on the market designed to perform this task. Such devices are known as “shearers”, “tin snips”, “nibblers” and “grinders” and are either manual or electrical. It is common for plumbers and other tradespeople to own and use many of these devices, the reason being that each device may possess cutting techniques which the others do not.

There are many different designs and profiles of sheet metal on the market. For example, the metal may be ribbed, crimped or corrugated, and in places can be folded over twice or more to create reinforced seams and lock seams. The terms “ribbing” and “lock seaming” are used to describe a profile for strengthening whereby two or more pieces of sheet metal overlap and are joined together. The result of “ribbing” or “lock seaming” is that the metal is thicker and more difficult to cut. A “lock-seam” is where multiple pieces of metal are locked together in the manufacturing process. Given these different types of sheet metal characteristics and profiles, the ideal cutting device must be able to twist and turn and cut through sheet metal which angles in many different directions and/or incorporates overlapping seams and/or ribbing (eg. spiral ducting).

The inventor of the present invention is a plumber. The invention arose because the existing devices on the market were unsatisfactory for cutting through the various profiles of sheet metal roofing. The present invention is able to cut through all common sheet metal profiles on the market. It is specially designed to cut sheet metal which angles upwards and downwards as per the design of the profile, which most standard tools cannot easily do.

The present invention is a manual tool which produces a “cold cut”. There are many electrical devices on the market, namely nibblers, grinders, shearers and saws. Grinders and saws produce hot cuts and nibblers and shearers produce cold cuts. The disadvantages of using grinders and saws, which produce a hot cut, are:
the risk of fire;
metal dust or “swarf” is created thus making the metal vulnerable to rust;
cleaning up of the “swarf” is time consuming but vital.

Given the above disadvantages of hot cutting, cold cutting is markedly preferable.

Electrical devices which produce a cold cut (eg. nibblers and shearers) are unable to cut through ribs, folds and seams.

Most sheet metal cutting devices lift the sheet metal as it is cut, thus interfering with the cutting process. The present invention does not lift or distort the metal as it is cut and each cut is a clean cut.

### BRIEF DESCRIPTION OF INVENTION

This invention relates to a sheet metal cutting device and is depicted in the attached schematic drawings (FIG. 1 to FIG. 6). Its primary function is to cut holes in sheet metal. More particularly, its function is to cut through and over the many different profiles and designs of sheet metal roofing, ducting (square or round), cladding and metal decking.

Its overall size is similar to that of long handle pruning secateurs. The long handles 4 & 5 enable the cutting to be strong, effective and user friendly. The handles 4 & 5 are not novel, however of note is that they are particularly long as compared to other sheet metal cutting devices.

The novel feature of the present invention is the way the straight cutting blade 13 is designed to pass through two curved support blades 12 & 14 which are square sharpened at 90 degrees on their inside edges (henceforth referred to as “curved support blades”). This enables the cutting to follow the grooves and shapes of sheet metal profiles.

The present invention is able to overcome all obstacles which can prevent the cutting of fixed sheet metal. It can cut through any sheet metal including sheet metal with profiles, folds, ribs, seams, underlay insulation, safety mesh or any other associated obstacle. Most importantly, a slotted, clean cut is produced with efficiency and ease.

The present invention is a manual tool which eliminates the awkwardness and distortion associated with cutting angles, folds, ribs, beading and lock seams. Its cutting is easier, quicker and cleaner than other devices and is ideal for cutting roof profiles, ducting and any fixed sheet metal material.

### BRIEF DESCRIPTION OF THE DRAWINGS

FIG. 1 is a perspective view of the present invention;

FIG. 2 is a side view of the present invention;

FIG. 3 is a front view of the present invention;

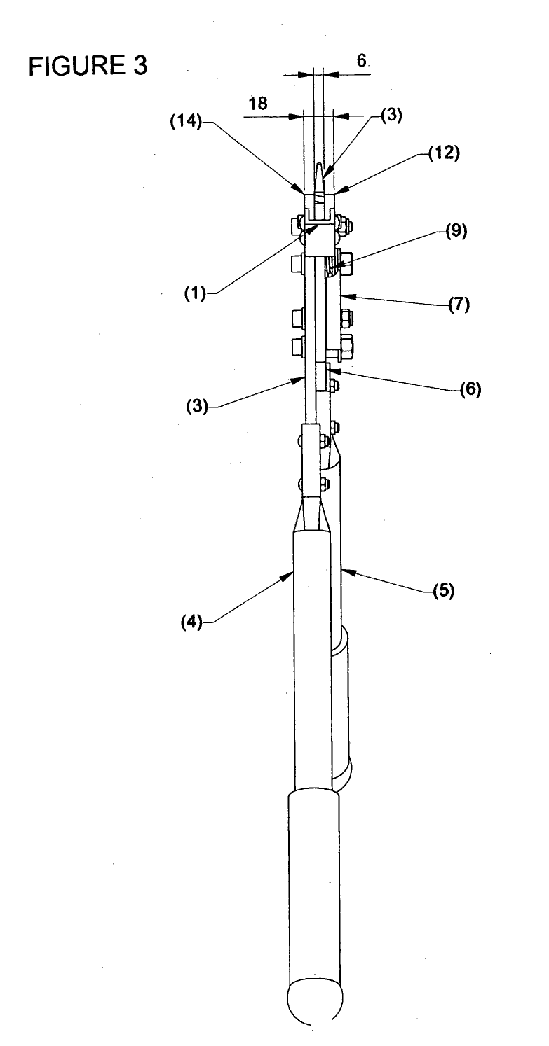

FIG. 4 is an aerial view of the present invention;

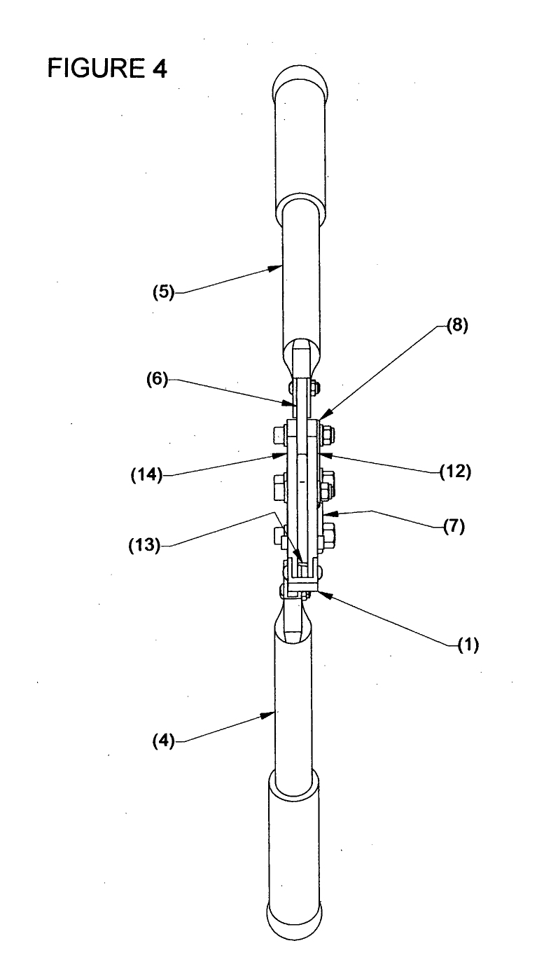

FIG. 5 is a perspective view of the present invention;

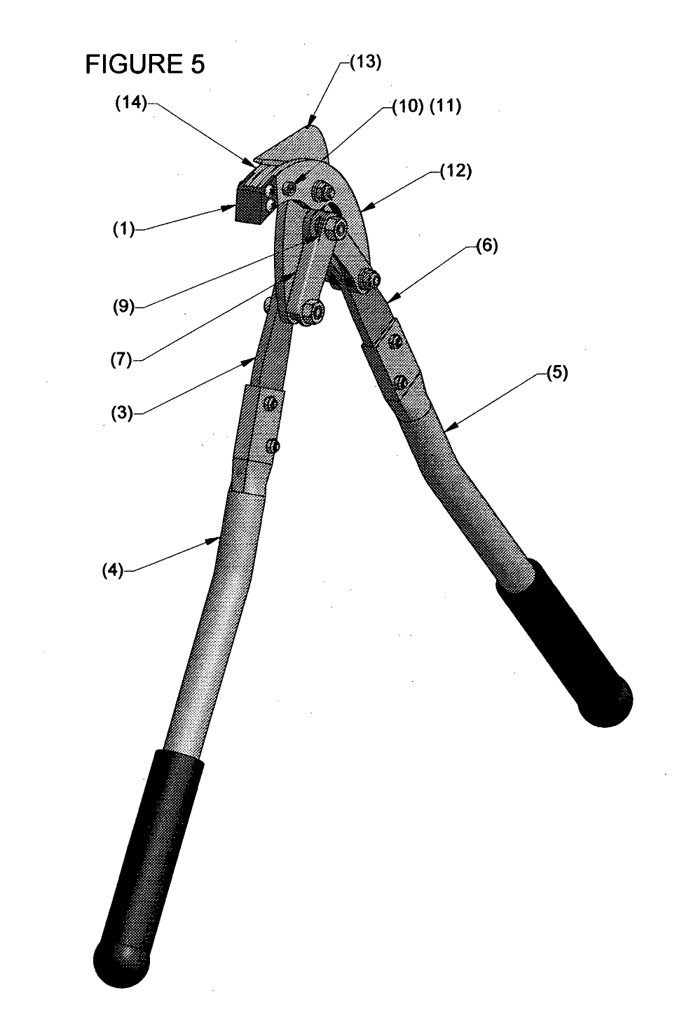

FIG. 6 is a perspective view of the present invention from a different angle to FIG. 5;

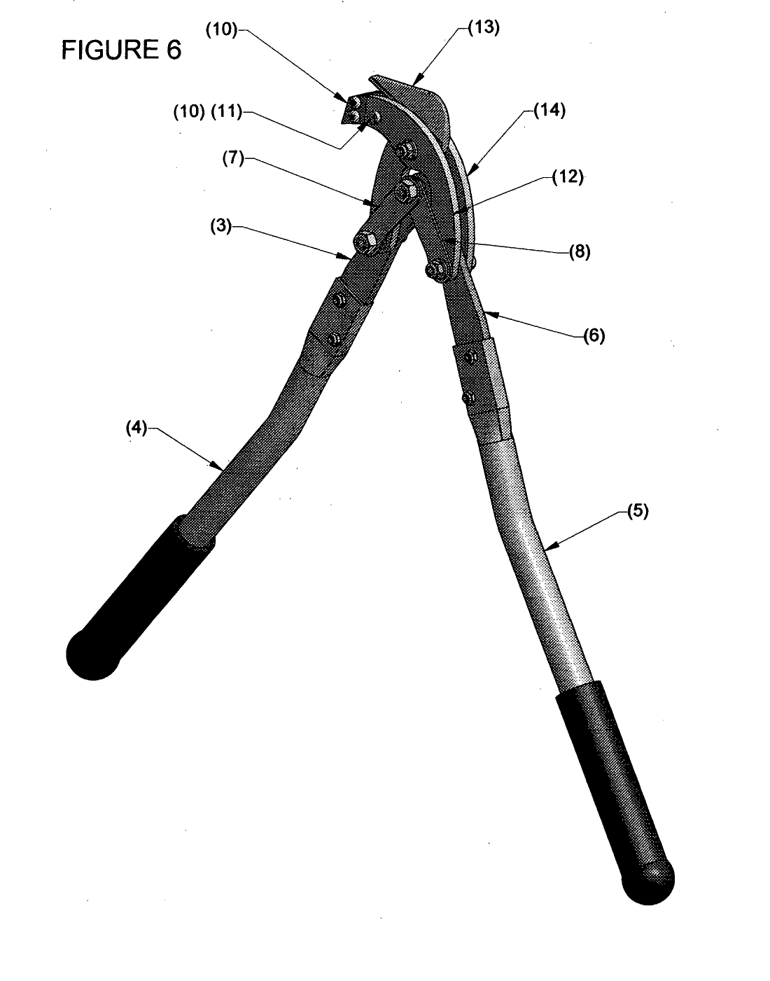

All figures contain number references which correspond to the same parts.

### DETAILED DESCRIPTION OF THE INVENTION

It is the principal object of the present invention to provide improvements in the field of cutting sheet metal profiles. Drawings are enclosed to assist with understanding the invention.

The cutting section of the present invention is what is novel. The cutting section consists of four major parts:
1: the cutting blade 13;
2: the curved support blade 12;
3: the curved support blade 14;
4: the blade bracket 1.

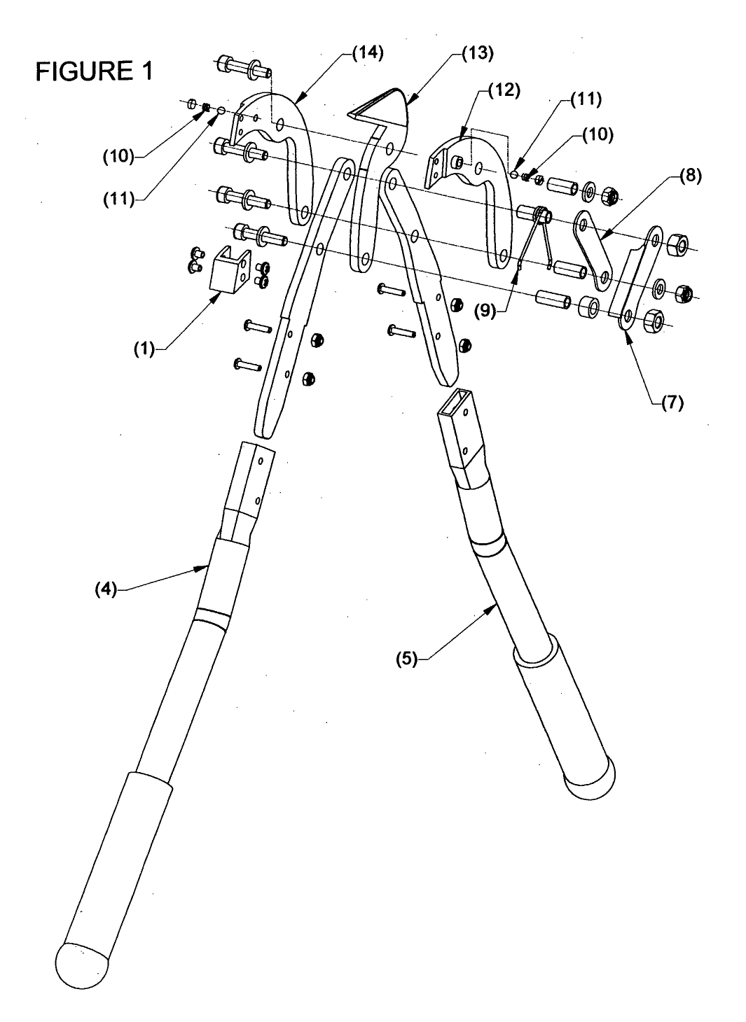

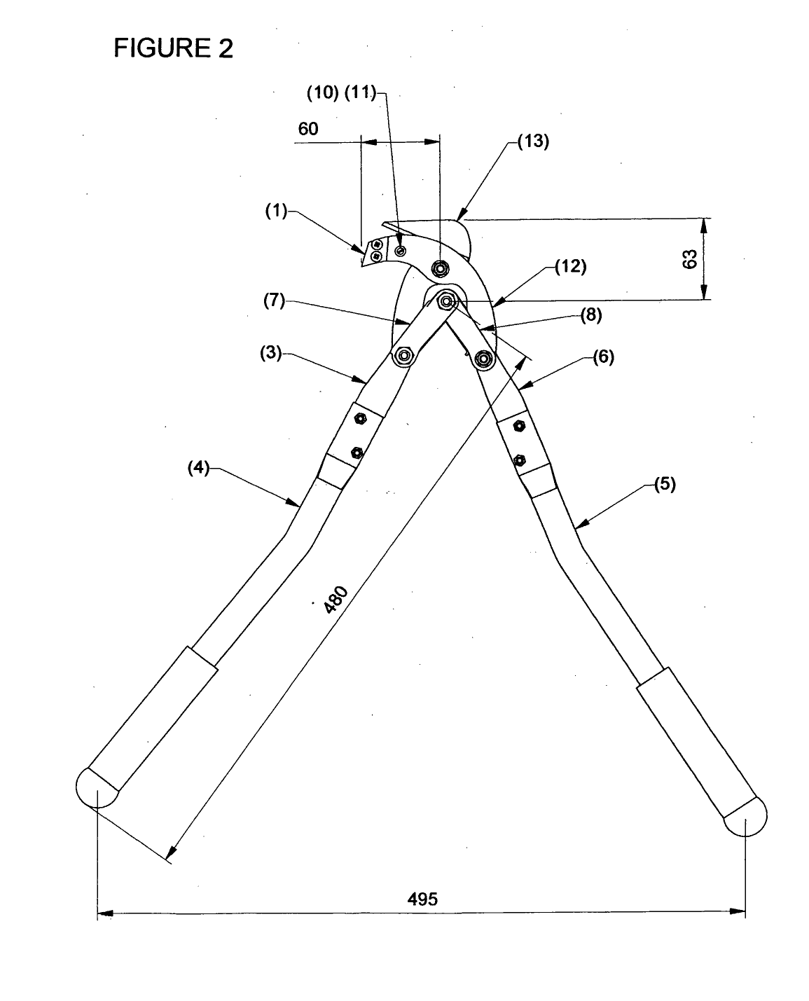

The shapes of the cutting blade 13, the two curved support blades 12 & 14 and the blade bracket 1 are evident in FIGS. 1, 2 & 5. The curved support blades 12 & 14 are square sharpened at 90 degrees on their inside edges and are placed on either side of the cutting blade 13 to create a hole in which the blade can pass through. Of note is that the blade 13 is straight and that the two supports 12 & 14 are curved away from the cutting blade 13. The curved support blades 12 & 14 are held in place by the blade bracket 1 which connects onto their ends and are each held in place by two screws—see FIG. 1. The blade bracket 1 also acts as a blade because it is splayed at the centre of its inside surface and sharpened at this point to allow for each cut to be complete.

The cutting blade 13 and the curved support blades 12 & 14 each have two holes in them (henceforth referred to as upper and lower holes) which enable them to be connected together and to the handles 4 & 5. The handles 4 & 5 are long with rubber grips commonly used in long handle pruning secateurs. Items 3 & 6 form part of the handles by slotting into 4 & 5 and are connected together by way of two screws each. Items 3 & 6 each have two holes in them (henceforth referred to as upper and lower holes) which enable them to be connected together and to the cutting blade 13 and the curved support blades 12 & 14. Items 3 & 6 are bolted together at their upper holes. The cutting blade 13 and the curved support blades 12 & 14 are bolted together at their upper holes, with the cutting blade 13 fitting between the two curved support blades 12 & 14.

There are four major places where the integral parts of the cutting section meet. The first is where the upper holes of items 3 & 6 connect. The second is where the lower hole of the cutting blade 13 connects with the lower hole of item 3. The third is where the lower holes of the two curved support blades 12 & 14 connect with the lower hole of item 6. The fourth is where the upper hole of the cutting blade 13 connects with the upper holes of the two curved support blades 12 & 14. These four areas are referred to respectively as “1^{st}, 2^{nd}, 3^{rd} and 4^{th} Bolt Sections” below.

Particular to all Bolt Sections is that the bolt used is an Allen screw-bolt (that is, a screw-bolt with a hexagonal socket in the head which can be turned by an Allen key). A small metal cylinder (“cylinder”) covers each Allen screw-bolt to enable the movement and interaction of the parts to be smooth. Standard small washers are used directly near the head of each Allen screw-bolt and directly near each nut. The cylinder over the Allen screw-bolts also fits inside the lower and upper holes of items 3, 6, 12, 13 & 14 and therefore the circular holes in these items are cut to allow the circumference of the cylinders to fit inside.

Particular to Bolt Sections 1, 2 & 3 is that they connect with items 7 & 8. Items 7 & 8 are used to create a place where the inner side of curved support blade 12 can enter when the handles 4 & 5 are pulled together. Items 7 & 8 each have two holes in them (henceforth referred to as upper and lower holes) which enable them to be connected at the said Bolt Sections. See FIG. 1.

### 1^{st} Bolt Section

The Allen screw-bolt is inserted through the upper holes of items 3 & 6. The upper holes of items 7 & 8 are also connected here, as is a spring loaded clip. The spring loaded clip assists in smoothing the motion of the handles 4 & 5 when they move together and apart. The order of items connected between the Allen screw-bolt and the nut at the end, without reference to the cylinder or washers, are: 14, 13, 12, spring loaded clip, 8 & 7.

### 2^{nd} Bolt Section

The Allen screw-bolt is inserted through the lower hole of item 3 and the lower hole of the cutting blade 13. The lower hole of item 7 is also connected here, together with a larger cylinder which fits over the cylinder. The larger cylinder acts to support the gap between items 13 and 7. The order of items connected between the Allen screw-bolt and the nut at the end, without reference to the cylinder or washers, are: 3, 13, larger cylinder & 7.

### 3^{rd} Bolt Section

The Allen screw-bolt is inserted through the lower holes of the curved support blades 12 & 14 and the lower hole of item 6. The order of items connected between the Allen screw-bolt and the nut at the end, without reference to the cylinder or washers, are: 14, 6, 12, 8.

### 4^{th} Bolt Section

The Allen screw-bolt is inserted through the upper hole of the cutting blade 13 and the upper holes of the curved support blades 12 & 14. The order of items connected between the Allen screw-bolt and the nut at the end, without reference to the cylinder or washers, are: 14, 13, 12.

The curved support blades 12 & 14 are mounted together by a bracket 1 which is screwed into the ends of the curved support blades 12 & 14. A section of each curved support blade 12 & 14 are cut out to allow the bracket 1 to connect into place. The gap between the curved support blades 12 & 14 is the width of item 6 which is also the width of the cutting blade 13.

When the handles 4 & 5 are pulled towards each other, the lower holes of the cutting blade 13 and item 3 (on the one part) and the lower holes of the curved supports 12 & 14 and item 6 (on the other part) are pulled together. This allows the tips of the curved support blades 12 & 14 (on the one part) and the tip of the cutting blade 13 (on the other part) to move together and for the cutting blade 13 to pass through the hole created by the curved support blades 12 & 14.

The curved support blades 12 & 14 each have a spring loaded ball bearing 10 & 11 held in place by a screw. This stops the piece of metal which is being cut from dropping back into the tool. Each ball bearing 11 slightly protrudes from each curved support blade and is pushed back into the curved support blade when the cutting blade 13 passes into it.

Items 3 & 6 slot into the handles 4 & 5 and are each secured by two screws. The upper holes of items 3 & 6 connect at the 1^{st} Bolt Section. The handles 4 & 5 are angled out slightly towards the bottom to allow for the user's hands not to hit each other when the handles 4 & 5 are brought together.

The dimensions of the present invention are indicated in FIG. 2. These dimensions can vary, but the general proportions of the parts should remain similar.

It is envisaged that other items may be used instead of the Allen screw-bolts and nuts to improve the overall appearance of the present invention or to limit the amount of protruding objects.

1. A device for cutting sheet metal, in particular sheet metal profiles commonly used for roofing, ducting and cladding, whereby the cutting blade passes through two curved sharpened support blades which are on either side of the central cutting blade and which are curved away from the cutting blade.

2. A device for cutting sheet metal as claimed in claim 1 wherein the cutting blade is straight.

3. A device for cutting sheet metal as claimed in claim 1 wherein the two curved sharpened support blades are square sharpened at 90 degrees on their inside edges.

4. The device designed to cut through sheet metal profiles as herein described with reference to the accompanying drawings.
